(19) United States
(12) Patent Application Publication
(10) Pub. No.: US 2002/0065829 A1
(43) Pub. Date: May 30, 2002

(54) Apparatus and method for synchronizing databases in distributed communication systems

(76) Inventors: Ralf Neuhaus, Lunen (DE); Rainer Uecker, Mulheim (DE)

Correspondence Address: BELL, BOYD & LLOYD, LLC, P. O. BOX 1135, CHICAGO, IL, 60690-1135, US

(21) Appl. No.: 09/954,833

(22) Filed: Sep. 17, 2001

(30) Foreign Application Priority Data
Sep. 19, 2000 (DE) 10046319.3

(51) Int. Cl. G06F 7/00

(52) U.S. Cl. 707/100

(57) ABSTRACT

Apparatus and method for synchronizing databases in distributed communication systems utilizing a server for a preferably private communication system having a number of communications installations connected to one another via a network, the server including a central database for centrally storing data for the individual communications installations and a central synchronization device which synchronizes the data between the central database and the individual communications installations.

### BACKGROUND OF THE INVENTION

The present invention relates to a server for a communication system including one or more interconnected communications installations, a communications installation for this communication system and a method for synchronizing databases arranged in the communications installations and/or the server.

Modem communication systems frequently include a number of physically distributed, interlinked communications installations. In this context, each of these communications installations has its own switching intelligence and its own local database for storing data specific to the communications installation. The local databases specific to the communications installations are in this case used for storing data required for independent operation (i.e., standalone operation) of a communications installation. For example, this data may include subscriber numbers, authorizations, exchange lines, direct-dial numbers, call numbers, configuration data and shortcode dialing destinations. To produce a network interconnection of networked communications installations from these communications installations, the individual communications installations each need to be configured appropriately. That is, they need to be brought into line with the data stored in the other communications installations.

To achieve the appropriate configuration, it is necessary, in particular, to allocate a consistent and unique call number plan for the entire communication system between the individual communications installations. Other data that is valid across the network interconnection also needs to be configured appropriately and synchronized in each of the individual communications installations.

One disadvantage of this configuration is that maintaining and servicing the local databases is very complex and is prone to error by virtue of the quantity of data which needs to be managed. For example, changing the call number plan in one of the communications installations requires that these changes also be reflected in the other communications installations of the communication system. In addition, manual administration of the communications installations can result in a call number being allocated more than once within the communication system.

An object of the present invention is, therefore, to provide a method and a device which permit simple administration and synchronization of databases within a communication system.

### SUMMARY OF THE INVENTION

On the basis of the present invention, a central server includes a central, all-embracing server database storing at least some of the data stored in local client databases of the respective communications installations. The central database thus contains a depiction of at least some of the data of the respective local databases. The data specific to the communications installations (first data) includes information necessary for operating the respective communications installation.

One advantage of the present invention is that a preferably private communication system having interlinked communications installations looks like a single communication system from the outside. This allows central management and administration of the local databases of the individual communications installations to be conducted in a simple manner.

Advantageously, the server includes an administration device allowing central management and administration of the central and local databases. In this context, first data changed in the central database is transmitted to the appropriate communications installation, where the first data of the local database is updated.

The first data changed in the central database may be data which affects a number of communications installations within the communication system. Therefore, the server of the present invention contains a central checking device which checks whether changed first data are data affecting a number of communications installations and which updates these data for the appropriate communications installations in the central database if the result of the check is positive. The changed data are then synchronized with the respective local databases by a central synchronization device, (i.e., the data is sent to the respective communications installations, in which the data in the local databases is updated).

Changes to call number plans are examples of first data which, when changed in a local database of a communications installation, entail a change in further local databases of further communications installations. A call number plan contains information about which call numbers of the communication system are associated with which communications installation. In the event of a change in the call number plan of a communications installation, the new call number plan needs to be appropriately adjusted in all other communications installations within the communication system. Otherwise, unique connection setup (i.e., the unique assignment of a call number to a communication device) is no longer possible if identical call numbers are allocated within the communication system.

The server and the communications installation of the present invention respectively have a central and local updating device for receiving the changed first data which has been sent by the respective other apparatus via the network. In this context, the central and local updating devices update the received data in the corresponding central or local database.

Optionally, the central database of the server can provide second data, which are not stored in the respective communications installations and are not directly needed for operating a communications installation. A local access device provides the communications installation of the present invention with access to these second data. The second data can likewise be centrally administered and managed using the central administration device in the server.

Additional features and advantages of the present invention are described in, and will be apparent from, the following Detailed Description of the Invention and the Figures.

### BRIEF DESCRIPTION OF THE FIGURES

FIG. 1 shows a schematic illustration of a server and of communications installations in accordance with the principles of the present invention.

FIG. 2 shows an exemplary embodiment of a private communication system having a number of interlinked communications installations in accordance with the principles of the present invention.

### DETAILED DESCRIPTION OF THE INVENTION

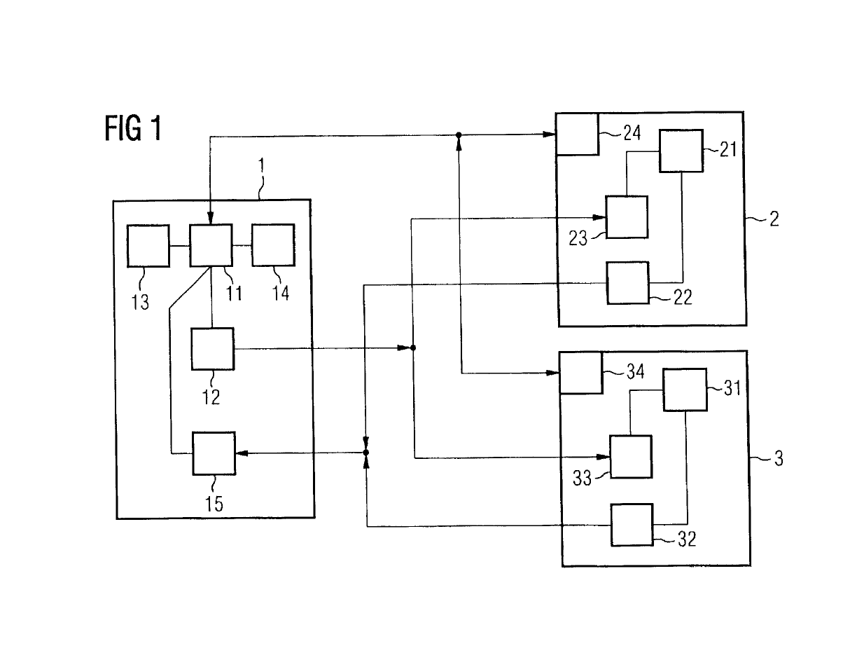

FIG. 1 shows a schematic illustration of a server 1 in a preferably private communication system or communication network in accordance with the principles of the present invention. The server 1 is connected to one or more communications installations 2, 3 via a network. The communications installations 2, 3 each have a local database 21, 31 for storing data specific to the communications installations (hereinafter referred to as first data). In this context, the connecting lines with arrows indicate the direction in which messages or data are interchanged between the communications installations 2, 3 themselves or between the server 1 and the communications installations 2, 3. In the present exemplary embodiment, the network is an IP-oriented (Internet Protocol) network, in which data is transmitted using a transmission protocol based on the IP protocol.

The central unit of the server 1 is formed by a central database 11, which stores a depiction (copy) of the individual local databases 21, 31 of the respective communications installations 2, 3 or parts of these local databases 21, 31.

A central synchronization device 12 of the server 1 monitors the central database 11 for any change to first data, required for operating a communications installation 2, 3, for example, stored in the central database 11. If first data affecting one or more communications installations 2, 3 has been changed in the central database 11, then the changed first data is transmitted by the central sychronization device 12 to the appropriate communications installation(s) 2, 3 via the network. The communications installations 2, 3 receive the changed data via a local updating device 23, 33 which is arranged in the respective communications installation 2, 3 and is used to update the first data stored in the respective local database 21, 31.

The first data can be centrally administered and managed using a central administration device 13. A central checking device 14 of the server 1 checks whether changed first data affecting a communications installation 2, 3 result in a change to first data in other communications installations 2, 3 (e.g., when a call number plan is changed) and automatically updates these first data in the central database 11. The first data changed in this manner are then transmitted to the appropriate other communications installations 2, 3 via the network, as a result of which the first data stored in the local databases 21, 31 of the appropriate communications installations 2, 3 are updated.

If data in a local database 21, 31 in one of the communications installations 2, 3 is changed (e.g., an entry for a shortcode dialing destination), then this entry also needs to be updated appropriately in the central database 11. For this purpose, the communications installations 2, 3 contain a respective local synchronization device 22, 32 monitoring the appropriate local database 21, 31 for changes. In cases in which first data in a local database 21, 31 are changed, the local synchronization device 22, 32 transmits the changed first data to the server 1 via the network. The changed first data is received by a central updating device 15 and is entered into the central database 11.

In addition, the communications installations 2, 3 can use a respective local access device 24, 34 to access second data, stored in a central database 11, which is not available in the respective local databases 21, 31.

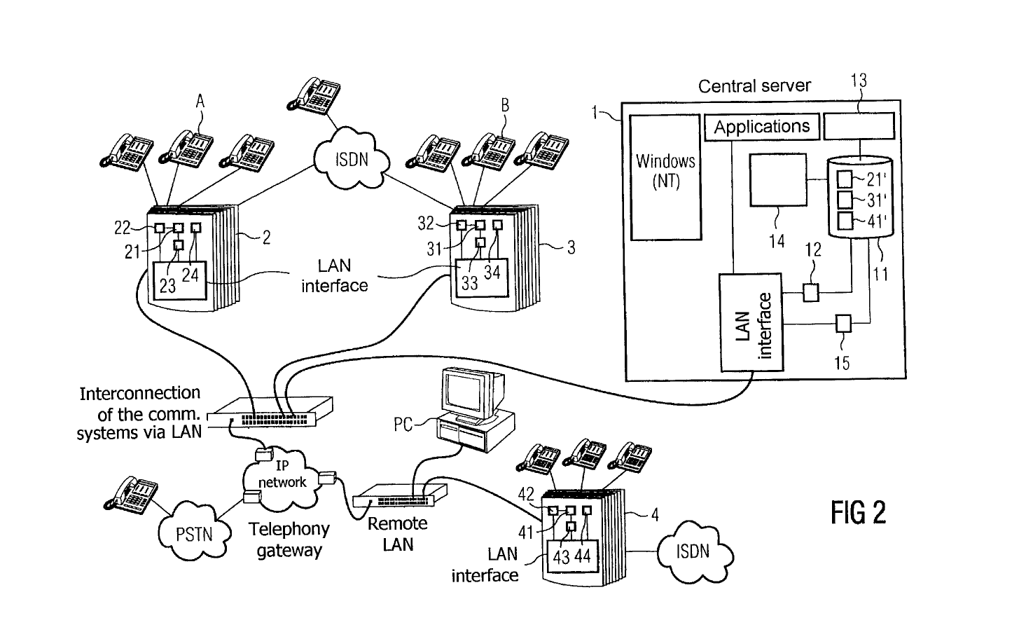

FIG. 2 shows one preferred embodiment of a distributed communication system having three communications installations 2, 3, 4 and a central server 1. Connected to the communications installations 2, 3, 4 are a respective number of communication terminals (e.g., telephones). In the present exemplary embodiment, the communications installations 2, 3, 4 are networked via a local area network (LAN) in which data are transmitted using the IP protocol. Alternatively, the communications installations 2, 3, 4 can also be networked using a tunneling mechanism via circuit-switched networks (e.g., an ISDN-oriented communication network). In this case, the messages of a networking protocol specific to the communications installation are, by way of example, packaged into appropriate messages of the transmission protocol (e.g., IP, ISDN) and are sent via the network.

In the present exemplary embodiment, the communications installations 2, 3, 4 are connected to one another via an Ethernet LAN and can interchange signaling and voice data via this Ethernet LAN. The individual communications installations 2, 3, 4 are connected to the LAN via a respective LAN interface implemented in each of the communications installations 2, 3, 4. Each communications installation 2, 3, 4 has a local database 21, 31, 41 for storing first data specific to the communications ion.

Incorporated in the central server 1 is an all-embracing central database 11 containing a depiction of all the first data 21′, 31′, 41′ or of at least some of the first data of all the communications installations 2, 3, 4 arranged in the communications system. Between the server 1 and the communications installations 2, 3, 4, there is a network connection for bidirectional data interchange. A central synchronization device 12 of the server 1 and local synchronization devices 22, 32, 42 of the communications installations 2, 3, 4 ensure that, in the event of a change to first data in the central database 11 or in one of the local databases 21, 31, 41, the corresponding first data in the respective communications installations 2, 3, 4 or in the server 1 are automatically updated. The central database 11, combined in this way, represents a depiction of the whole communication system, formed from a number of communications installations 2, 3, 4, in the representation of a single system (Single System Image).

The central database 11 can be viewed, altered and/or configured by an appropriately designed central administration device 13. In addition, a central checking device 14 of the server 1 is used to provide a consistency check, so that, by way of example, it is not possible to allocate call numbers twice within the communications system. Besides the first data of the individual communications installations 2, 3, 4, the central database 11 also contains additional information (hereinafter referred to as second data) relating to the communications installations 2, 3, 4. The second data contains information such as the address of a communications installation 2, 3, 4 in the network, this additional information being significant to the communication network.

From the outside and from the administrative point of view, this possibly worldwide system interconnection acts like a single installation and can also be administered like such an installation. The central database 11 is likewise accessed for cross operations between the communications installations 2, 3, 4. By way of example, when a first subscriber A on the communications installation 2 calls a second subscriber B on the communications installation 3, the server 1 can provide all the necessary information (second data), such as name and address, relating to the desired second subscriber B. If the communications installation 2 does not know the location of the desired second subscriber B, then this can be requested via the central database 11 using the local access device 24, 34, 44. In this way, it is not absolutely necessary for each communications installation 2, 3, 4 to have available all the locations of the subscribers in the whole communication system. Similarly, FIG. 2 shows the central updating device 15, explained with reference to FIG. 1, and the respective local updating devices 23, 33, 43.

Joint central administration can also be carried out and used for individual systems which are at a great physical distance from one another (e.g., in other towns and countries) and are, for example, connected to one another via an IP network (Internet).

The server 1 can also provide additional applications, for example, to extend the functionality of the communications installations 2, 3, 4, such as service features and CTI applications (Computer Telephony Integration). To this end, the server 1 holds an operating system (e.g., Windows NT) holding the individual software components.

Although the present invention has been described with reference to specific embodiments, those of skill in the art will recognize that changes may be made thereto without departing from the spirit and scope of the invention as set forth in the hereafter appended claims.

1. A server for a communication system, the server comprising:
a plurality of communications installations connected to one another via a network, the communications installations each having a local database for storing first data;
a central database for storing at least some of the first data stored in the local databases of the respective communications installations; and
a central synchronization device for monitoring the central database for changes to the first data affecting the communications installations and for transmitting the changed first data to the respective communications installation via the network.

2. A server for a communication system as claimed in claim 1, the server further comprising a central checking device for checking whether the changed first data affect a plurality of communications installations, and for updating the changed first data in the respective communications installations if a result of the check is positive.

3. A server for a communication system as claimed in claim 2, wherein the first data are call number plans affecting operation of a plurality of communications installations.

4. A server for a communication system as claimed in claim 1, the server further comprising a central updating device for receiving the first data which have been changed in a local database of a communications installation and have been transmitted to the server via the network, and for updating the first data in the central database.

5. A server for a communication system as claimed in claim 1, wherein the central database provides second data for the respective communications installations.

6. A server for a communication system as claimed in claim 5, the server further comprising a central administration device for centrally administering the first and second data in the central database.

7. A server for a communication system as claimed in claim 1, wherein the network is an IP-oriented network.

8. A communications installation for a communication system, wherein the communication system includes a plurality of communications installations connected to one another via a network, the communications installation comprising a local database for storing first data, and a local synchronization device for monitoring at least some of the data stored in the local database for changes and for transmitting changed first data via the network to a server arranged in the network.

9. A communications installation for a communication system as claimed in claim 8, the communications installation further comprising a local updating device for receiving the first data which affect the communications installation and have been changed in a central database of the server, and for updating the changed first data in the local database.

10. A communications installation for a communication system as claimed in claim 9, the communications installation further comprising a local access device for accessing second data stored in the central database.

11. A method for synchronizing both local databases arranged in communications installations and a central database of a server in a communication system, the communications installations and the server being connected to one another via a network, the method comprising the steps of:
storing a copy of at least some of the first data stored in the local databases of the respective communications installations in the central database;
monitoring the central database for changes to the first data affecting a communications installation;
transmitting changed first data to the respective communications installation via the network if which a change has been made to the first data;
monitoring the local data bases for changes to the first data; and
transmitting the changed first data from the appropriate communications installation to the server via the network if a change has been made to the first data.

12. A method for synchronizing databases as claimed in claim 11, the method further comprising the steps of:
receiving, at a communications installation, first data changed in the central database; and
updating the changed first data in the local database of the communications installation.

13. A method for synchronizing databases as claimed in claim 11, the method further comprising the steps of:
receiving, at the server, first data changed in a local database; and
updating the changed first data in the central database of the server.

14. A method for synchronizing databases as claimed in claim 11, the method further comprising the steps of:
checking the changed first data to determine whether the changed first data affect a plurality of communications installations; and
updating the first data in the appropriate communications installations if a result of the check is positive.

15. A method for synchronizing databases as claimed in claim 14, wherein the first data affecting a plurality of communications installations are call number plans.

16. A method for synchronizing databases as claimed in claim 11, the method further comprising the step of providing second data for the communications installations via the central database.

17. A method for synchronizing databases as claimed in claim 16, the method further comprising the step of accessing the second data stored in the central database via the communications installations.
